(19) United States
(12) Patent Application Publication
(10) Pub. No.: US 2014/0250895 A1
(43) Pub. Date: Sep. 11, 2014

(54) MODULATED EJECTOR COOLING

(71) Applicant: UNITED TECHNOLOGIES CORPORATION, Hartford, CT (US)

(72) Inventors: Shawn M. McMahon, Agawam, MA (US); Steven M. Miller, Tolland, CT (US); Debora F. Kehret, Manchester, CT (US); Russell P. Parrish, Glastonbury, CT (US); Sean P. Zamora, Coventry, CT (US); Nicholas James Behlman, Colchester, CT (US)

(73) Assignee: UNITED TECHNOLOGIES CORPORATION, Hartford, CT (US)

(21) Appl. No.: 14/202,342

(22) Filed: Mar. 10, 2014

Related U.S. Application Data
(60) Provisional application No. 61/775,787, filed on Mar. 11, 2013.

(51) Int. Cl. F02K 1/82; F02C 7/18; F02C 9/18

(52) U.S. Cl. CPC F02K 1/822; F02C 9/18; F02C 7/18
USPC 60/766; 60/266; 60/806

(57) ABSTRACT

A cooling air flow ejector has a primary nozzle position to entrain air from a secondary nozzle. Mixed air is provided into a downstream flow conduit to be directed to an exhaust liner for a gas turbine engine. A variable area device controls a volume of air passing through a primary nozzle. A control for the variable area device to control the size of an orifice within the variable area device controls the volume of air reaching the exhaust liner to be cooled.

### CROSS-REFERENCE TO RELATED APPLICATION

This application claims priority to U.S. Provisional Application No. 61/775,787, filed Mar. 11, 2013.

### BACKGROUND

This application relates to a cooling scheme for a gas turbine engine exhaust liner.

Gas turbine engines typically include a fan delivering air into a bypass duct and into a core engine. Air in the core engine passes into a compressor where it is compressed and then passed into a combustion chamber. The air is mixed with fuel and ignited in the combustor and products of this combustion pass downstream over turbine rotors, driving them to rotate.

In some engines, particularly those for military applications, a nozzle is provided downstream of the core engine that may include an augmentor. The augmentor injects fuel into the products of combustion downstream of the turbine and causes a secondary combustion which increases the thrust of the engine.

In such applications, the nozzle has a liner which may become very hot. As such, it is known to provide cooling air to the nozzle. One known scheme includes capturing fan air from the bypass duct and passing it through a primary nozzle. This air acts as a venturi to entrain an increased volume of air from a bay associated with the aircraft. The air is then passed along the liner.

Prior art systems do not include a way to modify the volume of cooling air flow. Accordingly, the volume of cooling airflow is typically designed to provide cooling for the highest heat loads. Accordingly, at less than the highest heating loads, excess cooling air is provided that reduces overall engine efficiency.

### SUMMARY

In a featured embodiment, a cooling air flow ejector has a primary nozzle positioned to entrain air from a secondary nozzle and provide mixed air into a downstream flow conduit to be directed to an exhaust liner for a gas turbine engine. A variable area device controls a volume of air passing through the primary nozzle. A control for the variable area device controls the volume of air reaching the exhaust liner to be cooled. The variable area device includes an orifice of a size varied by the control.

In another embodiment according to the previous embodiment, the variable area device is positioned upstream of the primary nozzle.

In another embodiment according to any of the previous embodiments, the primary nozzle is positioned to one side of the secondary nozzle.

In another embodiment according to any of the previous embodiments, the primary nozzle is surrounded by the secondary nozzle.

In another featured embodiment, a gas turbine engine has a core engine section, and an exhaust nozzle including an exhaust liner downstream of the core engine. A cooling air flow ejector cools the exhaust nozzle. The cooling airflow ejector includes a primary nozzle positioned to entrain air from a secondary nozzle and provide mixed air into a passage to be directed to the exhaust liner. A variable area device includes a variable orifice for controlling a volume of air passing through the primary nozzle. A control controls the variable area device to vary the size of the variable orifice to control the volume of air reaching the exhaust liner.

In another embodiment according to the previous embodiment, the variable area device is positioned upstream of the primary nozzle.

In another embodiment according to any of the previous embodiments, the primary nozzle is positioned to one side of the secondary nozzle.

In another embodiment according to any of the previous embodiments, the primary nozzle is surrounded by the secondary nozzle.

In another embodiment according to any of the previous embodiments, a fan section is driven by the core engine section. Air delivered to the primary nozzle is taken from a bypass duct for the fan of the gas turbine engine.

In another embodiment according to any of the previous embodiments, the secondary nozzle receives air from a bay associated with an aircraft structure supporting the gas turbine engine.

In another embodiment according to any of the previous embodiments, the variable area device is moved towards a position to reduce air flow to the primary nozzle when a cooling requirement on the exhaust liner is reduced, and increased when the cooling requirement is increased.

In another embodiment according to any of the previous embodiments, the variable area device is moved to reduce air flow to the primary nozzle when an associated aircraft is operating at one of a cruise condition and a higher altitude.

In another embodiment according to any of the previous embodiments, the variable area device is moved towards a more open position when an associated aircraft is at one of a take-off condition and at high Mach number operation at lower altitudes.

In another embodiment according to any of the previous embodiments, a gas turbine engine has a core engine, and a fan section driven by the core engine. The fan section includes a bypass duct. An exhaust nozzle includes an exhaust liner downstream of the core engine. A cooling airflow ejector cools the exhaust nozzle. The cooling airflow ejector includes a primary nozzle positioned to entrain air from a secondary nozzle to provide mixed air into a passage directed to the exhaust liner. A variable area device controls a volume of air passing through the primary nozzle. A control for governing operation of the variable area device controls the volume of air reaching the exhaust liner. The variable area device is positioned upstream of the primary nozzle. Air delivered to the primary nozzle is from the bypass duct. The secondary nozzle receives air from a bay associated with an aircraft supporting the gas turbine engine.

In another embodiment according to any of the previous embodiments, the primary nozzle is positioned to one side of the secondary nozzle.

In another embodiment according to any of the previous embodiments, the primary nozzle is surrounded by the secondary nozzle.

In another embodiment according to any of the previous embodiments, the variable area device is controlled to reduce air flow to the primary nozzle when a heat load on the exhaust liner is reduced. The variable area device is controlled to increase airflow to the primary nozzle when the heat load is increased.

In another embodiment according to any of the previous embodiments, the variable area device is moved to reduce air flow to the primary nozzle when an associated aircraft is operating at one of a cruise condition and a higher altitude.

In another embodiment according to any of the previous embodiments, the variable area device is moved towards a more open position when an associated aircraft is at one of a take-off condition and at high Mach number operation at lower altitudes.

These and other features may be best understood from the following drawings and specification.

### BRIEF DESCRIPTION OF THE DRAWINGS

FIG. 1 shows a schematic of a gas turbine engine.

FIG. 2 shows a prior art ejector system.

FIG. 3 shows a schematic view of an example ejector.

FIG. 4 shows a schematic view of another example ejector.

### DETAILED DESCRIPTION

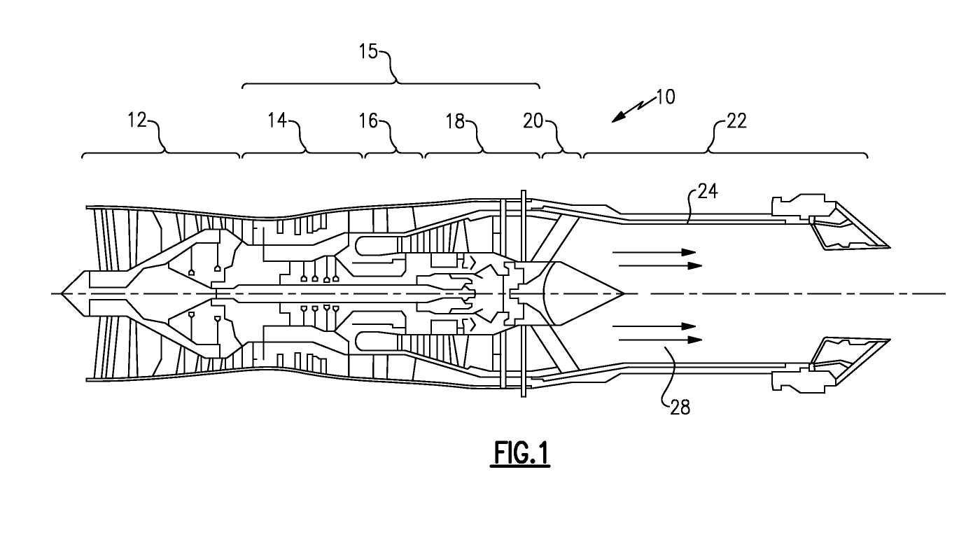

Referring to FIG. 1, a gas turbine engine 10 includes a fan section 12, and a core engine section 15 including a compressor section 14, a combustor section 16, and a turbine section 18. Air entering into the fan section 12 is initially compressed and fed to the compressor section 14. In the compressor section 14, the incoming air from the fan section 12 is further compressed and communicated to the combustor section 16. In the combustor section 16, the compressed air is mixed with gas and ignited to generate a hot exhaust stream 28. The hot exhaust stream 28 is expanded through the turbine section 18 to drive the fan section 12 and the compressor section 14.

In this example, the gas turbine engine 10 includes an augmenter section 20 where additional fuel can be mixed with the exhaust gasses 28 and ignited to generate additional thrust. The exhaust gasses 28 flow from the turbine section 18 and the augmenter section 20 through an exhaust nozzle 22. The exhaust nozzle 22 includes an exhaust liner 24 that insulates outer structures from the hot combustion gases 28.

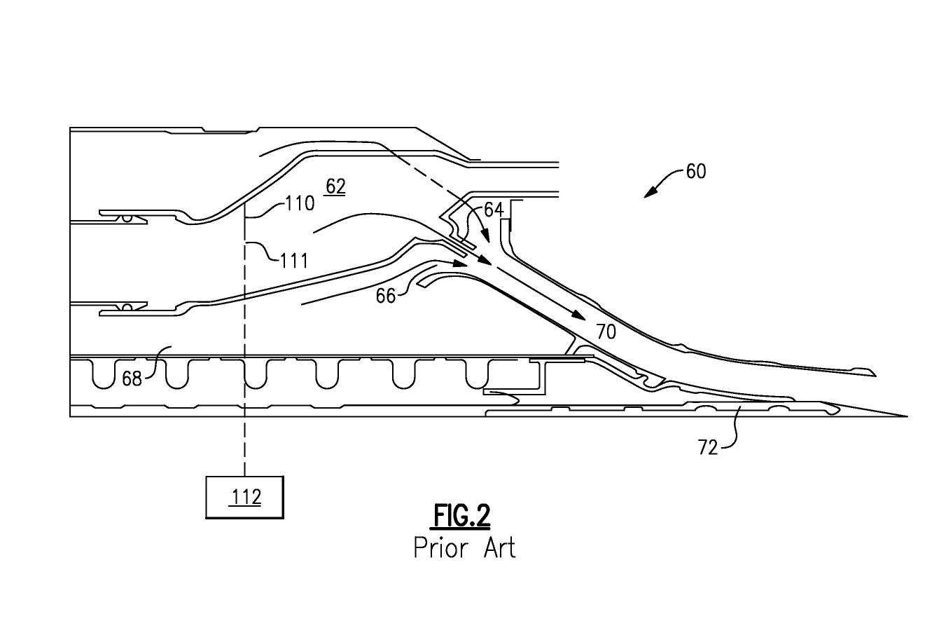

As shown in FIG. 2, a known liner 72 which is associated with the exhaust nozzle 22, such as shown in FIG. 1 and is provided with cooling air through an ejector system 60. Fan air from a chamber 62 is tapped from a bypass duct and directed through a primary nozzle 64. The primary nozzle 64 acts as a venturi nozzle and entrains additional air from a chamber 68 which is exposed to aircraft bay air. The bay is typically a space between the engine and an associated aircraft structure. The bay air is drawn through a secondary nozzle 66 and mixed with the fan air from the primary nozzle 64, such that the air reaching a passage 70 is a combination of the two air flows. Prior art systems provide no way of varying the volume of air delivered to the liner 72.

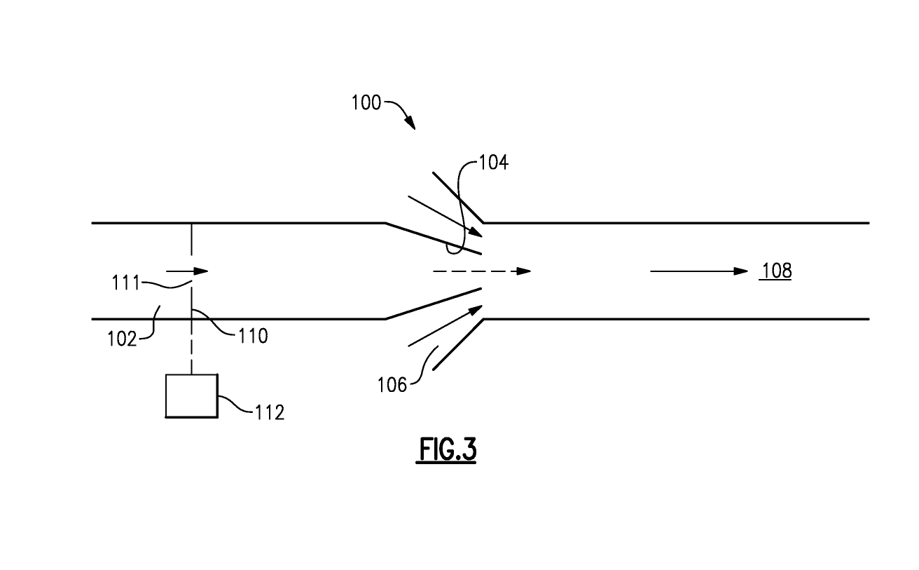

FIG. 3 shows an ejector system 100 which improves upon the prior art. A fan air source 102 passes through a variable area device 110 controlled by a control 112. The air passes downstream through a primary nozzle 104 creating a venturi effect and entrains bay air through a secondary nozzle 106. The primary nozzle 104 is surrounded by the secondary nozzle 106. This mixed air passes to a passage 108 which is then passed along to the liner 24 (FIG. 1). The variable area device 110 is upstream of the primary nozzle 104.

The variable area device 110 may have the area of an orifice 111 varied as controlled by the control 112. The control 112 may be a full authority digital electric controller (FADEC) for the engine or may be a standalone control. Variable area devices are known that can serve to rapidly change the area of orifice 111.

When higher volume cooling air is necessary, the control 112 opens the orifice 111 in the variable area device 110 to enable further air flow to reach the primary nozzle 104.

On the other hand, at times when a lower volume of cooling air is necessary, the orifice 111 in the variable area device 110 is moved toward a more closed position to reduce air flow.

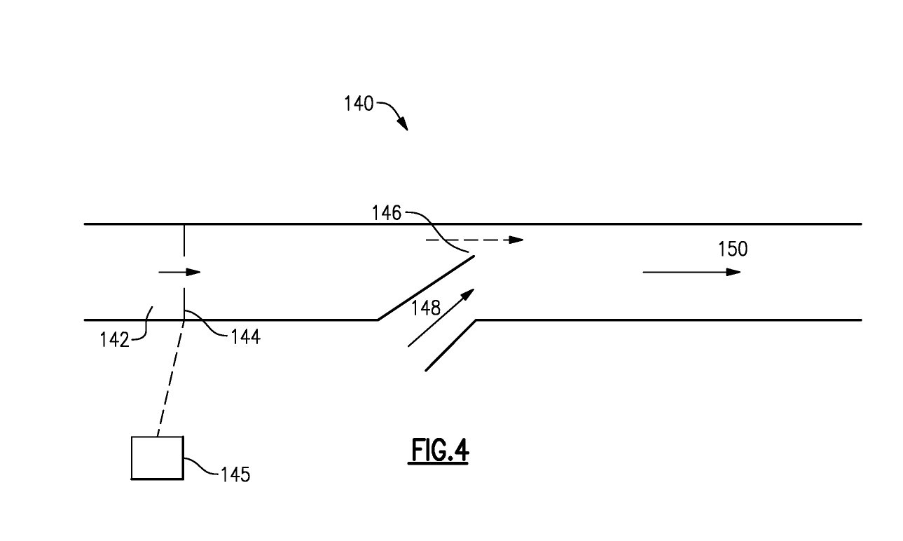

FIG. 4 shows another embodiment 140 where air from fan air source 142 passes through a variable area device 144 with an orifice size controlled by a control 145, as in the first embodiment. A primary nozzle 146 is positioned on one side of secondary nozzle 148. A mixed airflow in passage 150 passes to the exhaust liner 24 (FIG. 1).

Conditions which would typically require the higher air flow may be take-off or high Mach number operation at lower altitudes. In general, conditions which would result in higher temperatures within the engine and exhaust nozzle would benefit from higher cooling air flow. On the other hand, the airflow is reduced at cooler operating conditions. Cooler As an example, cruise conditions at high altitudes would suggest a smaller volume of cooling air flow.

A worker of ordinary skill in the art would recognize when the variable area device 110 should be controlled.

Although an embodiment of this invention has been disclosed, a worker of ordinary skill in this art would recognize that certain modifications would come within the scope of this invention. For that reason, the following claims should be studied to determine the true scope and content of this invention.

1. A cooling air flow ejector comprising:
a primary nozzle positioned to entrain air from a secondary nozzle and provide mixed air into a downstream flow conduit to be directed to an exhaust liner for a gas turbine engine;
a variable area device for controlling a volume of air passing through said primary nozzle; and
a control for said variable area device to control the volume of air reaching the exhaust liner to be cooled, wherein the variable area device includes an orifice of a size varied by the control.

2. The cooling air flow ejector as set forth in claim 1, wherein said variable area device is positioned upstream of said primary nozzle.

3. The cooling air flow ejector as set forth in claim 1, wherein said primary nozzle is positioned to one side of said secondary nozzle.

4. The cooling air flow ejector as set forth in claim 1, wherein said primary nozzle is surrounded by said secondary nozzle.

5. A gas turbine engine comprising:
a core engine section;
an exhaust nozzle including an exhaust liner downstream of the core engine;
a cooling air flow ejector for cooling said exhaust nozzle, wherein said cooling airflow ejector includes a primary nozzle positioned to entrain air from a secondary nozzle and provide mixed air into a passage to be directed to the exhaust liner and a variable area device including a variable orifice for controlling a volume of air passing through the primary nozzle; and
a control for controlling the variable area device to vary the size of the variable orifice to control the volume of air reaching the exhaust liner.

6. The gas turbine engine as set forth in claim 5, wherein said variable area device is positioned upstream of said primary nozzle.

7. The gas turbine engine as set forth in claim 5, wherein said primary nozzle is positioned to one side of said secondary nozzle.

8. The gas turbine engine as set forth in claim 5, wherein said primary nozzle is surrounded by said secondary nozzle.

9. The gas turbine engine as set forth in claim 5, including a fan section driven by the core engine section, wherein air delivered to the primary nozzle is taken from a bypass duct for the fan of said gas turbine engine.

10. The gas turbine engine as set forth in claim 5, wherein said secondary nozzle receives air from a bay associated with an aircraft structure supporting said gas turbine engine.

11. The gas turbine engine as set forth in claim 5, wherein said variable area device is moved towards a position to reduce air flow to the primary nozzle when a cooling requirement on the exhaust liner is reduced and increased when the cooling requirement is increased.

12. The gas turbine engine as set forth in claim 11, wherein said variable area device is moved to reduce air flow to the primary nozzle when an associated aircraft is operating at one of a cruise condition and a higher altitude.

13. The gas turbine engine as set forth in claim 12, wherein said variable area device is moved towards a more open position when an associated aircraft is at one of a take-off condition and at high Mach number operation at lower altitudes.

14. A gas turbine engine comprising:
a core engine;
a fan section driven by the core engine, the fan section including a bypass duct;
an exhaust nozzle including an exhaust liner downstream of said core engine;
a cooling airflow ejector for cooling said exhaust nozzle, wherein the cooling airflow ejector includes a primary nozzle positioned to entrain air from a secondary nozzle to provide mixed air into a passage directed to the exhaust liner and a variable area device for controlling a volume of air passing through said primary nozzle; and
a control for governing operation of said variable area device to control the volume of air reaching the exhaust liner, wherein said variable area device is positioned upstream of said primary nozzle and the air delivered to the primary nozzle is from the bypass duct and said secondary nozzle receives air from a bay associated with an aircraft supporting the gas turbine engine.

15. The gas turbine engine as set forth in claim 14, wherein said primary nozzle is positioned to one side of said secondary nozzle.

16. The gas turbine engine as set forth in claim 14, wherein said primary nozzle is surrounded by said secondary nozzle.

17. The gas turbine engine as set forth in claim 14, wherein said variable area device is controlled to reduce air flow to the primary nozzle when a heat load on the exhaust liner is reduced and the variable area device is controlled to increase airflow to the primary nozzle when the heat load is increased.

18. The gas turbine engine as set forth in claim 17, wherein said variable area device is moved to reduce air flow to the primary nozzle when an associated aircraft is operating at one of a cruise condition and a higher altitude.

19. The gas turbine engine as set forth in claim 18, wherein said variable area device is moved towards a more open position when an associated aircraft is at one of a take-off condition and at high Mach number operation at lower altitudes.
